(19) United States
(12) Patent Application Publication
(10) Pub. No.: US 2003/0069955 A1
(43) Pub. Date: Apr. 10, 2003

(54) SNMP agent object model

(76) Inventors: Eric James Gieseke, Lincoln, MA (US); Huimin Li, Shrewsbury, MA (US)

Correspondence Address: LEFFERT JAY & POLGLAZE, P.A., P.O. BOX 581009, MINNEAPOLIS, MN, 55458-1009, US

(21) Appl. No.: 09/972,775

(22) Filed: Oct. 5, 2001

(51) Int. Cl. G06F 15/173

(52) U.S. Cl. 709/223

(57) ABSTRACT

A SNMP agent and configuration server object model and method is detailed that manages configuration information and tasking of components, elements, and modules, of network elements, modular rack chassis's, and network systems. The SNMP agent and configuration server object model and method utilizes objects in an object oriented design approach to represent configuration information for managed modules and elements. This object oriented approach allows for ease of implementation, reduced errors, and faster generation for CLI command sets and MIB databases.

### TECHNICAL FIELD

The present invention relates generally to simple network management protocol (SNMP) agents and in particular the present invention relates to SNMP agent object models.

### BACKGROUND

Modern networks and network rack systems are typically constructed of multiple differing devices, elements, or links, referred to collectively herein as elements. These elements can each have multiple configurations, settings, and polices depending on the specific task the element has within the network or system. Additionally, the elements are often of a general application type such that they require configuration to perform their purpose in the network or network system. Examples of networks and network systems include cable modem networks and network modular rack systems.

Configuring and tasking an element in a networks or modular network rack systems is typically the job of a SNMP agent that is attached to or embedded in the network element. SNMP agents are typically internally comprised of configuration components that are utilized to generate the required configuration for the underlying system and hardware, typically with little or no processing effort by the SNMP agent. The configuration components in turn are typically generated at initialization of the SNMP agent from underlying configuration input files or information databases for all known hardware that is connected to the system or network element that the SNMP agent controls. Once the configuration components are initialized the SNMP agent can generate and send out the appropriate configurations to all requesting elements, devices, and services in the network element under management.

Networks and network systems are typically rarely ever static in their configuration and setup. Changes or additions are often quite frequently made to the network or system by users, administrators, or other programs and/or devices. These changes or additions are seen at the SNMP agent as “configuration change events” and have the effect of changing or adding to the configuration components maintained by the SNMP agent. A typical configuration change event is affected or initiated by a SNMP request to the SNMP agent. However, other configuration change events or inputs are possible.

To be able to manage a system the administrator or managing program must be able to know what it is capable of. In SNMP or through a command line interface (CLI) this is accomplished by the “show running config” command or by loading the required management information base (MIB). Upon receiving the “show running config” command, the SNMP agent generates a list of commands and configurations that the system or network element it manages is capable of.

Historically, implementations of the “show running config” CLI command generation can take a large amount of time to complete. Primarily, this is because of the large number of applications for elements in a network, the variability in the managed hardware and systems, and the variability of the individual element configuration. This is particularly the case with complex SNMP agents, such as a modular rack chassis, where a large number of applications for a modular rack chassis in a network, the variability in the inserted modules, and the variability of the individual module configuration add to the complexity of the task. The CLI Command set generation can also be a significant load on the SNMP agent and the network element, degrading performance. Generation of the CLI command set through inspection of MIB values can easily take over several minutes to complete.

Given the intricacy of SNMP implementation, particularly in complex systems there is difficulty in programming and verifying SNMP agents. This is particularly the case given frequent updates to the managed elements or modules and additions of new elements, hardware, systems, or modules to be managed.

The configuration components utilized by current SNMP agents typically are complex, specific to an applied purpose, and static in nature. This makes these configuration components challenging to verify, error prone, and difficult to repurpose to new components, modules, or elements. There is typically little code reuse among similar components. Further, each new component typically requires specialized programming specific to the component. No easy way to modify similar components in similar ways exists.

For the reasons stated above, and for other reasons stated below which will become apparent to those skilled in the art upon reading and understanding the present specification, there is a need in the art for a method of conveniently making, expanding, and operating configuration components in SNMP agents to allow managing and updating of configurations, components, and modules in a network environment.

### SUMMARY

The above-mentioned problems with conveniently making, expanding, and operating configuration components in SNMP agents to allow managing and updating of configurations, components, and modules in a network environment are addressed by embodiments of the present invention and will be understood by reading and studying the following specification.

In one embodiment, an object model includes, a plurality of objects, the plurality of objects adapted to contain configuration information and data for a simple network management (SNMP) agent.

In another embodiment, a computer-usable medium has computer readable instructions stored thereon for execution by a processor to perform a method. The method includes receiving configuration input, representing the received configuration input in object instances of a number of objects, the objects together forming an object model, and configuring an associated system.

In yet another embodiment a network element includes a memory, a network interface, a processor coupled to the memory and the network interface, and an object model. The object model includes a number of objects, the objects being adapted to contain configuration information and data for a configuration server.

In a further embodiment, an object model for a simple network management protocol (SNMP) agent includes, a number of objects, the objects being adapted to contain configuration information and data for one or more input configuration datum.

In yet a further embodiment, a network element has a memory, a network interface, a computer-usable medium for storing computer readable instructions, an object model, and a processor coupled to the memory, the computer-usable medium, and the network interface. The object model, includes a number of objects, the objects being adapted to contain configuration information and data for one or more input configuration datum.

In another embodiment, an object model includes a number of objects, the number of objects adapted to contain configuration information and data for a configuration server.

In yet another embodiment, a method of forming an object model includes receiving configuration input, and representing the received configuration input in object instances of a number of objects. The number of objects together form an object model.

In a further embodiment, a computer program executed by a processor performs a method. The method includes receiving configuration input, representing the received configuration input in object instances of a number of objects, the number of objects forming an object model, and responding to requests for configuration information.

In yet a further embodiment, a configuration server includes a memory, a network interface, a processor coupled to the memory and the network interface, and an object model. The object model includes a number of objects adapted to contain configuration information and data for a configuration server.

In another embodiment, an object model for a configuration server includes a number of objects adapted to contain configuration information and data for one or more input configuration datum.

In yet another embodiment, in a configuration server having a memory, a network interface, a computer-usable medium for storing computer readable instructions, and a processor coupled to the memory, the computer-usable medium, and the network interface, an object model including a number of objects adapted to contain configuration information and data for one or more input configuration datum.

Other embodiments are described and claimed.

### BRIEF DESCRIPTION OF THE DRAWINGS

FIG. 1A is a simplified diagram of a network element in a network.

FIG. 1B is a simplified diagram of a modular rack chassis in a network.

FIG. 2 is a simplified diagram of an embodiment of the present invention.

FIG. 3 is a simplified diagram of an object model of an embodiment of the present invention.

FIG. 4 is another simplified diagram of an object model of an embodiment of the present invention.

### DETAILED DESCRIPTION

In the following detailed description, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention include network elements that utilize object oriented programming techniques to model and configure their managed systems. Embodiments of the present invention include SNMP agents that utilize object oriented programming techniques to model and configure their managed systems. Embodiments of the present invention dynamically update their internal configuration components upon receiving a configuration change event and, additionally, allow for generation of a CLI command set without excessive loading of the network element or managed system or degradation of its performance. Embodiments of the present invention also include network configuration servers that utilize object oriented programming techniques to model and configure their managed system, which is typically a modular rack chassis for a network system. Embodiments of the present invention dynamically update their internal configuration components upon receiving a configuration change event and, additionally, allow for generation of a CLI command set without excessive loading of the configuration server or managed system or degradation of its performance.

Configuring and tasking the components or associated systems of a network element in a network is typically the job of a SNMP agent. Components in the present disclosure are defined to include all systems, such as hardware, software, firmware, polices, or services, associated with a network element that are managed by a SNMP agent. SNMP agents are internally comprised of configuration components that are utilized to generate a required configuration, typically with little or no processing effort by the SNMP agent, for the component of the network element that is being configured or requests configuration. The configuration components in turn are typically generated at initialization of the SNMP agent from underlying configuration input files or information databases for all known systems or components that are connected to the network element. Once the configuration components are initialized, the SNMP agent generates and sends out the appropriate configurations to all requesting systems, components, and services in the network element under management.

A configuration server is a more complex SNMP agent that is associated with a complex network system or modular network rack chassis system. Configuring and tasking elements in networks and modular network rack systems is typically the job of a configuration server. Configuration servers are also internally comprised of configuration components that are utilized to generate the required configuration, typically with little or no processing effort by the configuration server, for a particular network element or system element that requests it. The configuration components in turn are typically generated at initialization of the configuration server from underlying configuration input files or information databases for all known hardware that is connected to the system or network that the configuration server controls. Once the configuration components are initialized the configuration server can generate and send out the appropriate configurations to all requesting elements, devices, and services in the system or network under management.

As stated above, SNMP agents are a commonly used part of a network element that are used to configure network elements and to set policies and service levels within the network or network element. The SNMP agent is typically specific to a network element or one or more components that comprise a network element. An example of a common network element implementation that contains a SNMP agent is that of a hub, switch, router, or firewall wherein multiple network element types, network links, policies, service level agreements (SLAs), and quality of service agreements (QoS) exist. SNMP agents in a network element are responsible for implementing and maintaining a desired configuration for the network element and all associated components to match the application or applications that the network element is specifically being used for. In implementing and maintaining a desired system configuration, SNMP agents provide to each component or other associated system an appropriate configuration, policy setting, QoS, and/or SLA setting desired for that element. The configuration, policy setting, QoS, and/or SLA setting are referred to herein as a “configuration”. Network elements in this definition include, but are not limited to, network links, routers, cable modems (CMs), cable modem termination systems (CMTS), media termination adapters (MTAs), and SNMP compliant devices or agents.

As stated above, configuration servers are also a commonly used element of network environments that are used to configure network elements and to set policies and service levels. The configuration server is typically specific to a system or one or more rack frames of elements that comprise a system. An example of a common network implementation that contains a configuration server is that of a modular rack chassis in a cable modem (CM) network implementing data over cable service interface specification (DOCSIS) wherein multiple rack module types, cable modem types, network links, policies, SLAs, and QoS exist. Configuration servers in a network system or modular rack chassis are responsible for implementing and maintaining a desired configuration for the system and all elements to match the application or applications that the system is specifically being used for. Examples of such possible applications are a dynamic host configuration protocol (DHCP) server, a cable modem termination system (CMTS), etc. In implementing and maintaining a desired system configuration, configuration servers provide to each module or other network element the appropriate configuration, policy setting, QoS, and/or SLA setting desired for that element.

Configurable network elements in modem networks typically are managed through various interfaces, which generally include but are not limited to, a graphic user interface (GUI), SNMP, and a CLI. The most common of these are the SNMP interface and the CLI. In order to manage a configurable network element with an SNMP or CLI interface, the administrator or management program doing the management has to acquire knowledge of what the device is capable of and what can be set. This is typically done through loading the information or querying the network element for an SNMP MIB. A common approach, however is to issue a “show running config” command at the CLI interface which causes the network element to list the element's current configuration and the commands it is capable of. For a network element, this listing of current configuration in the form of a CLI command listing is controlled by the SNMP agent and covers each component that is associated with the network element. For a modular rack chassis, this listing of current configuration and command listing is controlled by the configuration server and covers each module inserted in the chassis. In other embodiments, the configuration also includes alarm configuration, protocol configuration, SNMP configuration, IP configuration, and the like. The listing for such elements of a modular rack chassis is typically in physical/logical order.

Configuration change events, which are events that require a change in one or more configuration components or files maintained by the SNMP agent or configuration server, occur on a frequent basis in networks and effect a change to the system or network being managed. In SNMP agent or configuration servers, the maintained configuration components or files, referred to herein as “configuration components”, are generated from configuration input files or information databases and reflect the desired state of the managed network or system. A typical configuration change event is effected or initiated by an SNMP request to the SNMP agent or configuration server. However, other configuration change events or inputs are possible. Configuration changes can also be introduced by human operators who modify the system configuration through the CLI, SNMP, or GUI interfaces. The configuration components are utilized to generate the CLI command listing to any entity that requests it via the CLI. In another embodiment, the configuration information is generated in the form of extensible markup language (XML).

In one embodiment, the configuration objects are transient, that is they are not persisted. The configuration objects are initialized when the system starts up, and are maintained over time to synchronize with the running configuration. When the system is shut down, the configuration objects are destroyed. In another embodiment, the configuration objects are persistent. In this embodiment, configuration objects are stored or persisted to a database or other mass storage. This serves to eliminate or reduce the need for initialization of objects at system startup.

Configuration change events typically require the regeneration of the configuration components of the SNMP agent or configuration server. Until a regeneration is done the SNMP agent or configuration server may not know which configuration components, and therefore which generated configurations that it sends to requesting devices or services, are up to date. The regeneration operation is resource intensive in past SNMP agents or configuration servers and can delay responses to configuration requests, as configuration component regeneration requires that the configuration server stop servicing configuration requests until all components are checked and updated. In the meanwhile, all devices that request a configuration are unable to complete their setup and therefore are unavailable to the network or system or end-user until regeneration is complete, a process that can take several minutes on complex systems. As configuration change requests are a frequent occurrence the probability of this delay is high. Certain SNMP agent or configuration server embodiments of the present invention contain methods internal to the objects that represent the configuration components that automatically update upon receiving a configuration change event that modifies the object or underlying configuration input files or information databases.

As stated above, the programming and setup of network element SNMP agents and complex SNMP agents such as configuration servers has traditionally been an intensive and time consuming process that has a high probability of error. This is due in part to the complexity of building CLI command sets based on system configuration stored in SNMP MIBs. The result is that there are often multiple updates of released products to fix implementation errors and reliability problems. Additionally, when new components, module types, or network element types must be added to the set of components, modules, or network elements that the configuration server or SNMP agent manages, this addition is also complex and very seldomly can reuse the same implementation code.

In some embodiments, SNMP agents or configuration servers of the present invention utilize an object oriented design (OOD) approach to implementation. In some embodiments of the present invention, components, modules, and elements of the, network element, modular rack chassis, or system are represented in the SNMP agent or configuration server by objects in an object model. This allows for the SNMP agent or configuration server to be wholly implemented with object oriented programming (OOP) or just the managed components, modules, and elements in an object model. This allows instances of these “configuration” objects to be the configuration components that are affected by configuration change events with the added benefit of being capable of internalizing object methods and attributes to aid in operation of the SNMP agent or configuration server embodiment of the present invention. The configuration components contain all configuration information and necessary attributes and routines to manage the corresponding component, module, or element that they represent.

As configuration change events come into the SNMP agent or configuration server the appropriate configuration object instance that contains the configuration component information for the component, element, or module that is being affected is notified and the component, module, or element that it manages is updated. In embodiments of the present invention configuration objects also allow for ease of configuration file import and export by coding the methods into the object for the module or element that they manage. In additional embodiments of the present invention, each configuration object knows the CLI commands and settings that its managed module or element accepts, allowing for the SNMP agent or configuration server to quickly generate “show running config” responses by simply querying the configuration objects. Each configuration object is also aware of the mapping between its attributes and the associated SNMP MIB objects. In addition, the configuration objects also know the mapping of their attributes to CLI command parameters. With this information, the configuration objects in one embodiment are able to derive the mapping from the CLI command parameter to an SNMP MIB object.

As objects in an OOP approach can inherit characteristics from parent object classes that they were built from, SNMP agent or configuration server embodiments of the present invention utilizing this technique allow for high amounts of code reuse in implementing configuration server embodiments of the present invention. The code reuse and “objectization” of managed system elements in embodiments of the present invention eliminates much of the code development time and problems with errors as repeatable sections are reused and code is compartmentalized. For example, a change correcting an error in a single underlying class or extension of a class is reflected in all other classes that incorporate them. Additionally, the OOP approach with its inheritance characteristics allow for ease of extending configuration server embodiments of the present invention to managing new devices or systems. In embodiments of the present invention building new classes, common elements are incorporated by inheritance from included object classes or a base object class and the object needs only to be extended to cover new functionality. Examples of object oriented languages that can allow for implementation of configuration server embodiments of the present invention include, but are not limited to, C++, Java, etc.

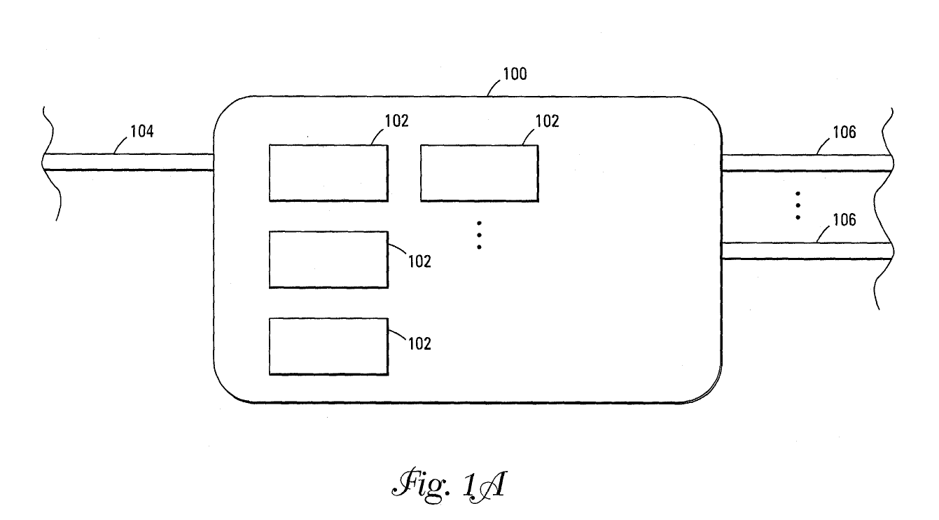

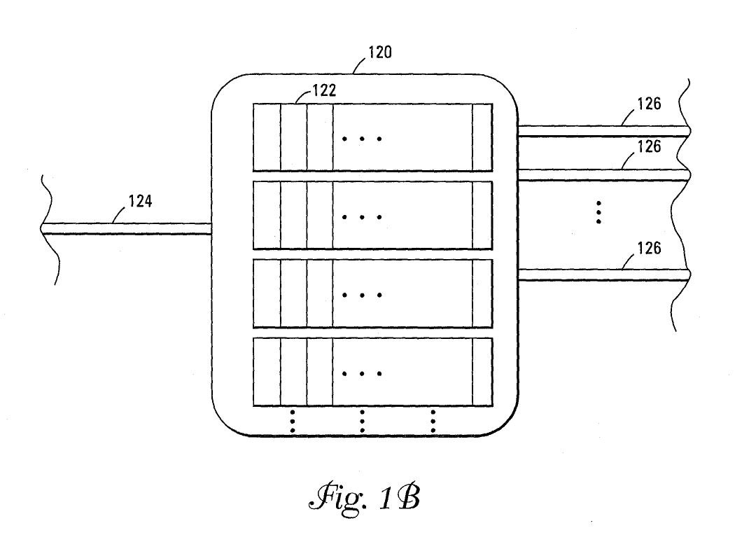

FIG. 1A is a simplified diagram of a network element 100. The network element 100 contains components 102 that are managed by a SNMP agent embodiment of the present invention. The network element 100 is coupled to one or more upstream networks 104, and one or more optional downstream networks 106. Other network connections and arrangements of the network element are possible. It is noted that SNMP agent embodiments of the present invention can manage other systems in addition to the detailed network element 100.

FIG. 1B is a simplified diagram of a modular rack chassis 120. The modular rack chassis 120 contains network support modules 122 managed by a configuration server embodiment of the present invention. The modular rack chassis 120 is coupled to one or more upstream networks 124, and one or more downstream networks 126. Other network connections and arrangements of the modular rack chassis are possible. It is noted that configuration server embodiments of the present invention can manage other systems in addition to the detailed modular rack chassis 120.

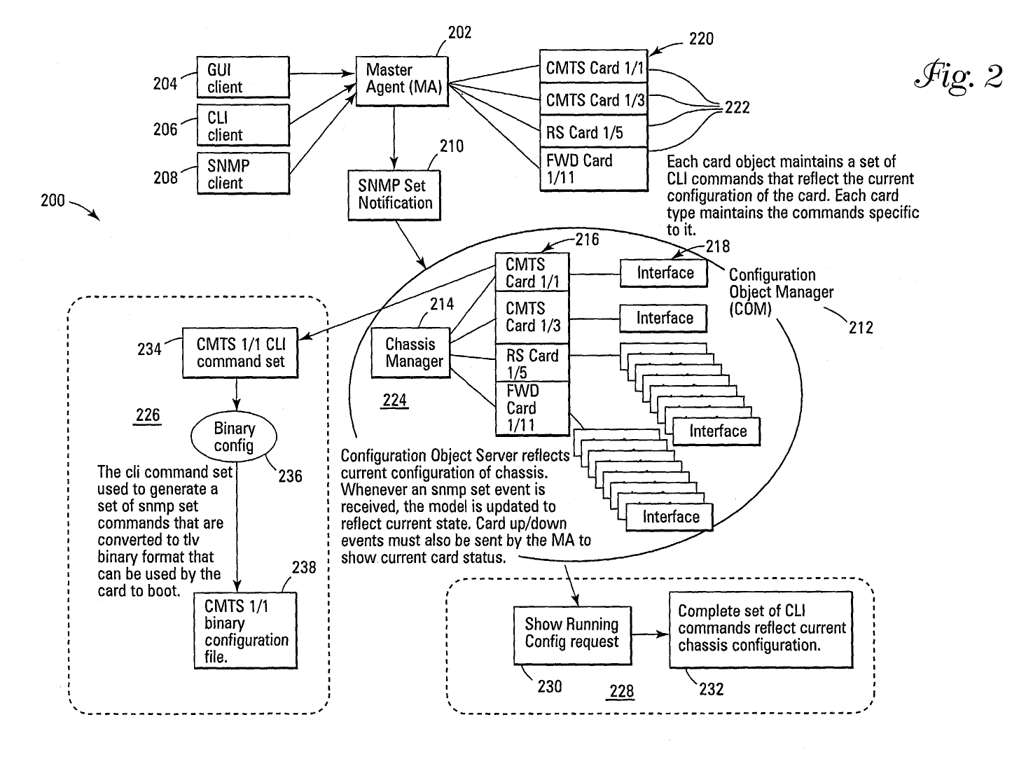

FIG. 2 is a simplified functional diagram of an embodiment of the present invention. In FIG. 2, a SNMP agent (a configuration server) for a network element (modular rack chassis system) 200 is represented in overview form showing components (modules) 222 inserted into a modular rack chassis 220, a master agent 202, GUI client 204, CLI client 206, SNMP client 208, configuration object manager (COM) 212, object instance hierarchy 224, and object instances 214, 216, and 218. In the diagram of FIG. 2 each component (module) 222 has a corresponding configuration object instance 216 in the object instance hierarchy 224 that contains all configuration parameters and interfaces necessary to configure and manage the component (module).

The object instance diagram 224 is the instantiation for the SNMP agent (configuration server) object model (not shown) and consists generally of instances of the chassis manager 214 object, individual component (module) instances 216, and the individual interface objects and low level object instances 218 that are incorporated into the component (module) instances 216. As stated above, internal to each object instance 214, 216, and 218 are the attributes and methods necessary to interact with the master agent 202, other objects 218, 216, 214, and 212, operate the represented component (chassis module) 222, and describe the current state of the component (module). Upon start up the object instance hierarchy 224 is instantiated through querying the associated MIB values for each object attribute in the SNMP agent (configuration server) 200 allowing SNMP agent (configuration server) 200 to reflect the desired state of the managed network or system. In another embodiment, the configuration objects are initialized from a database containing previous configurations.

In FIG. 2, all interactions with the network element (modular rack chassis system) 200 are handled by the system's master agent 202. The master agent 202 is a component of the SNMP agent system. The master agent accepts requests from SNMP clients, and either handles the requests itself if it is able to handle the request, or forwards the request to local agents on individual cards or modules if it is unable to handle the request. The master agent 202 is modified in one embodiment to send the configuration object server an SNMP set event message whenever a successful SNMP set event is processed by the master agent 202.

The master agent 202 interfaces with the GUI client 204, CLI client 206, and SNMP client 208 that handle the requests from administrators and management programs. The master agent also interacts with the COM 212 by passing SNMP set notifications 210 (configuration events), and with the component (modules) 222 in the network element (modular rack chassis) 220.

A configuration request comes in to the master agent 202 through one of the interface clients 204, 206, and 208. The configuration event is received by the master agent as a SNMP set request. After successfully processing a SNMP set request, the master agent 202 forwards a SNMP set event notification 210 to the COM 212. The SNMP set event notification contains in one embodiment the SNMP instance, MIB object ID, and MIB value. The COM 212 contacts the appropriate object instance 214, 216, or 218 for the physical or logical component (chassis module) 222 that is being addressed by the configuration event. At the object instance 214, 216, or 218, the configuration event invokes instance methods and/or sets internal attributes of the object instance 214, 216, or 218. In this way, the state of the configuration object instance is kept in synch with the corresponding physical or logical object in the chassis.

In FIG. 2, when a configuration request from a component (chassis module) 222 is received at the master agent 202 of an embodiment of a SNMP agent (configuration server) of the present invention, the request is passed through the COM 212 to the appropriate object instance 214, 216, or 218 that contains the configuration information for the component (chassis module) 222. The object instance 214, 216, or 218 updates its internal configuration to reflect the new values specified in the SNMP set event notification. Alternatively, the SNMP agent (configuration server) 200 directly configures a component (chassis module) 222 when needed, without waiting for a configuration request from the component (chassis module) 222. This is particularly the case where the component (chassis module) 222 is simple in construction and may not be able to request configuration.

Additional exemplary operations of the SNMP agent (configuration server) 200, the generation of binary configuration files 226 and CLI command set generation 228, are also shown in FIG. 2. When a “show running config” command is received 230 for CLI command set generation, the master agent 202 passes the command to the COM 212 for processing and creation of a CLI configuration command set that reflects the current network element or chassis configuration 232. Each object instance 214, 216, or 218 managed by the COM 212 knows how to generate the commands that reflect its configuration. Command sets for all object instances 214, 216, or 218 are aggregated together to create the complete command set for the network element or chassis. As each object instance 214, 216, or 218 only has to generate its portion of the command set the “show running config” operation is highly efficient. The chassis configuration is in another embodiment generated in the form of XML using the command “show running-config xml”.

In generating the CLI configuration command set the COM 212 of embodiments of the present invention can generate the command set in the following manner. The COM 212 “walks” the object instance hierarchy querying each object instance 214, 216, or 218 in turn for its portion of the command set. To optimize CLI command generation, each object in one embodiment caches the CLI commands generated in a previous request for the running configuration. In this way, the CLI commands can be reused if the associated configuration object has not been modified.

The individual CLI command sets 234 generated by the object instances 214, 216, or 218 that manage the individual components or chassis modules may be converted 236 in individual SNMP agent or configuration server embodiments of the present invention into binary configuration files 238, typically of type link value (TLV) format, that can be imported by the components (chassis modules) 222 for initialization purposes. This conversion 226 of the CLI command sets of the individual object instances 214, 216, or 218 is in various embodiments an internal method function of the object instances 214, 216, or 218 or a function of an additional object or function of the SNMP agent or configuration server embodiment.

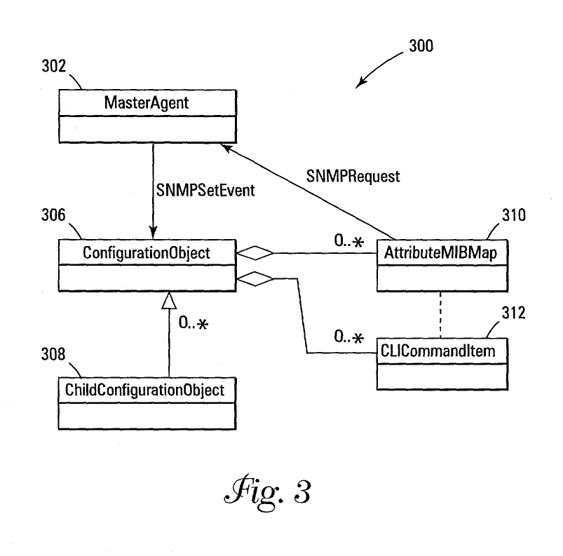

FIG. 3 is a simplified object model diagram showing an example of an object model 300 of an embodiment of the present invention. In FIG. 3, the object model 300 contains a master agent object 302, a base ConfigurationObject 306, derivative ChildConfigurationObjects 308, an AttributeMIBMap object 310, and a CLICommandItem object 312.

The ConfigurationObject 306 is the base object class for all ChildConfigurationObjects 308 utilized in the object model 300. The derivative ChildConfigurationObjects 308 extend the base ConfigurationObject 306 and further define and model the specific physical and logical components, elements, and modules of the system.

In mapping a SNMP set notification to an object attribute pair, the MasterAgent 302 notifies the COM (not shown) when a successful configuration event (SNMP set request) is processed. This allows the COM to update the object instances 306, 308 that represent of the state of the chassis. For each SNMP set notification, the COM receives a MIB name, instance, and value. The COM then updates the associated instance and attribute with the value. The update of an object instance due to a configuration event (SNMP set request) triggers rebuilding of the CLI command set for the modified object instance if necessary.

There are two available manners to map the SNMP set event received from the MasterAgent 302 to an object instance and attribute. First, starting with the chassis, the SNMPSetEvent is passed from parent object to child object within the ConfigurationObject 306, 308 hierarchy, using the instance to route the SNMPSetEvent to the correct object 306, 308. Second, each object instance attribute registers interest for SNMPSetEvents with a notification service. When the notification service receives an SNMP event corresponding to a MIB name and instance matching a registered object instance, the notification service then notifies the attribute with matching MIB name and instance, gaining the efficiency of not having to pass the SNMPSetEvent from object to object within the ConfigurationObject 306, 308 hierarchy. As stated above the notification service/mapping is handled in one embodiment by the objects of the AttributeMIBMap object class 310.

The AttributeMIBMap object class 310 aggregates attributes that map to a common MIB table. The AttributeMIBMap object class 310 in one embodiment contains a MIB table and provides methods for initialization of the object, computing the instance, and processing (data conversion) incoming and outgoing SNMP MIB name value pairs. The AttributeMIBMap object class 310 also contains methods to perform SNMP sets or gets. The AttributeMIBMap object class 310 contains values of the attribute name, MIB name, MIB type, default attribute value, current value, and last known value.

In mapping one or more ConfigurationObject 306, 308 instance attributes to a CLI command, which allows the appropriate ConfigurationObject 306, 308 instances and attributes to be utilized when a CLI “show running-config” command is received, the CLICommandItem objects 312 are used. The instances of the ConfigurationObjects 306, 308 each contain objects from the CLICommandItem object class 312 to handle the generation of each CLI configuration command required to represent their own configuration. Each ConfigurationObject class 306, 308 also knows its contained or dependent ChildConfigurationObject classes 308 (for example device, chassis, module, and interface) and delegates to the contained classes when it must generate a CLI command set (generally due to a “show running-config” command being received), allowing the contained or dependent ChildConfigurationObject classes 308 to generate their own CLI command sets. By this walking of the ConfigurationObject 306, 308 instance tree, commands for the entire managed network element, modular rack chassis, or system are generated. This method also groups the configuration commands by physical and logical components in one embodiment.

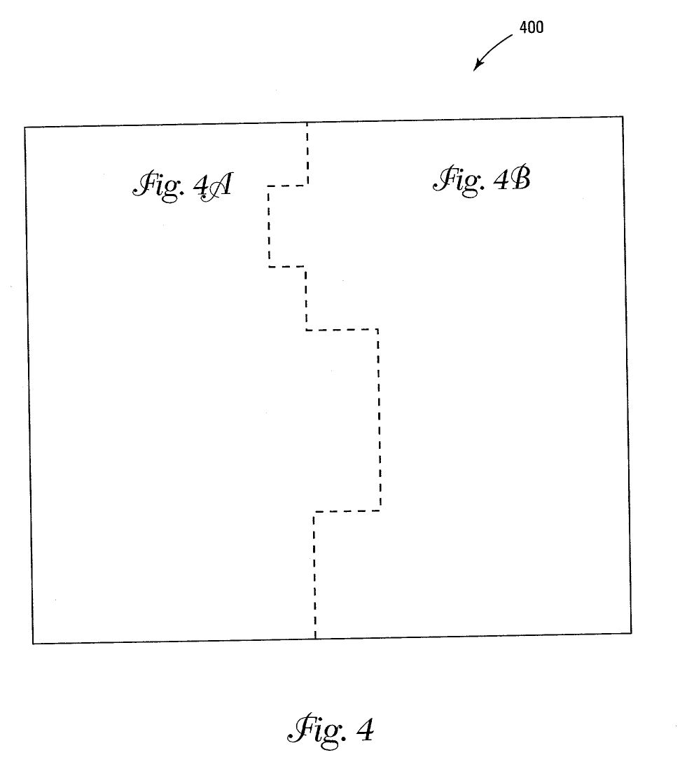

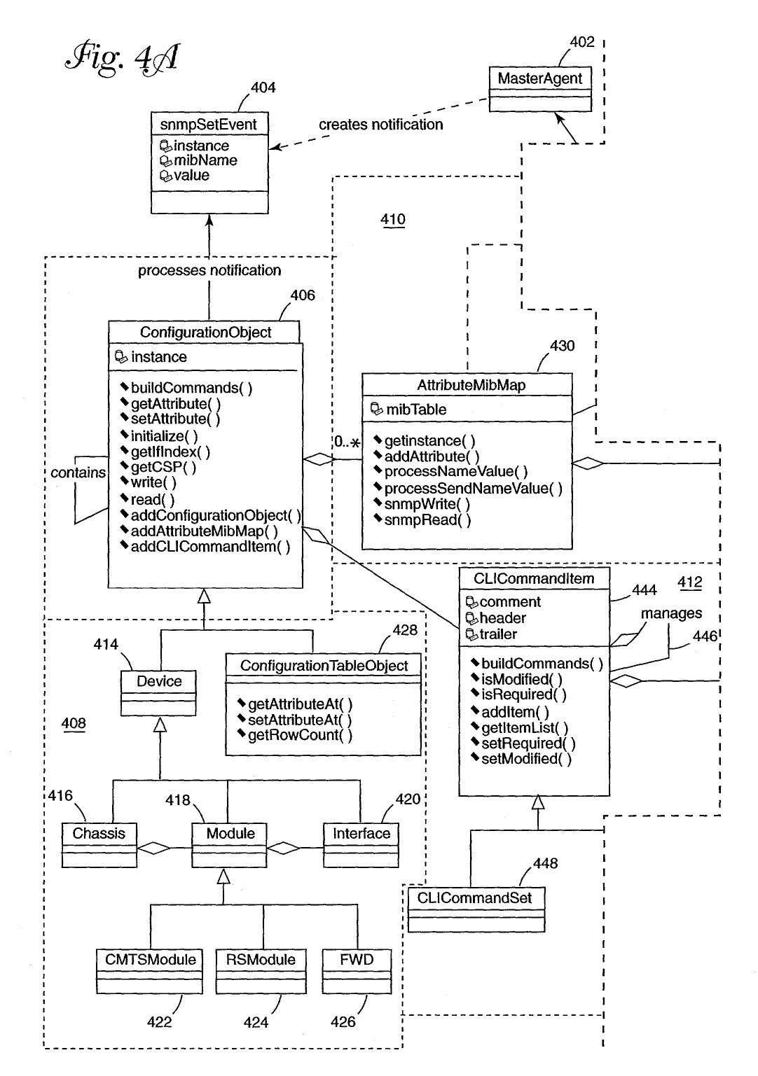

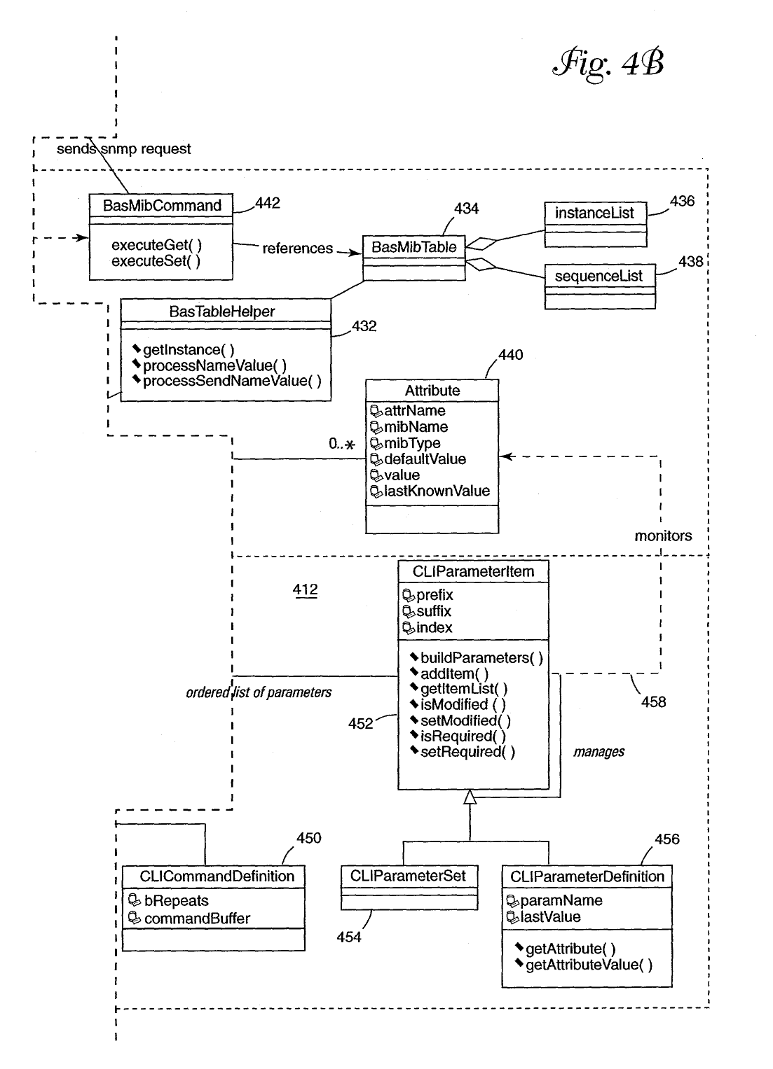

FIG. 4 is another simplified object model diagram showing additional detail of an example of an object model 400 of an embodiment of the present invention. In FIG. 4, the object model 400 contains a master agent object 402, an snmpSetEvent object 404, a base ConfigurationObject 406, a block of child configuration objects 408, a block of AttributeMIBMap objects 410, and a block of CLICommandItem objects 412.

The ConfigurationObject 406 is the base object class for all configuration objects 408 utilized in the object model 400. Configuration objects 408 model the physical and logical components of the system including the device 414, chassis 416, module 418, and interface 420. The chassis 416, module 418, and interface 420 objects extend the device object 414, which is itself an extension of the ConfigurationObject object 406. Each chassis object 416 can contain module 418 objects which in turn can contain interface 420 objects classes. The CMTSModule 422, RSModule 424, and FWD 420 are representative of classes that extend the module class 414 for specific module types that are in various embodiments inserted into the chassis and managed by the configuration server. Each class extension implements an initialization routine to instantiate any child objects. For example, the chassis object 416 instantiates instances for each module 418 in the chassis.

A ConfigurationTableObject 428 is derived from the base ConfigurationObject 406 and allows modeling of selected objects as rows within a table. Table objects are specialized objects that contain table data structures internal to the object which are utilized by the table object to virtually represent multiple other object instances. This virtual representation of what would otherwise be multiple object instances allows the table object to minimize the memory and processing impact on the configuration server because only one table object instance need be maintained. When a method or an attribute of an object instance that is virtually represented by a table object is referenced, the table object locates the instance's representation in its internal table and references the stored methods or attributes simulating the represented object instance. The represented object instances are preferentially similar in data attribute format and object methods to minimize the size of the table object's internal data table. If the methods of the represented object instances are identical in function, only a single set of methods need be maintained by the table object to operate on attributes taken from the internal table. Similarly, if the attributes are similar in number and format a single uniform table can be used by the table object to represent them.

However, object instances with differing methods and attributes can be efficiently represented by a table object if a small enough set of total differing methods and attributes are utilized. For this approach, the table object internally keeps track of which attributes and methods of the set a represented object instance has so that it accesses the appropriate versions upon reference to the represented object instance. This table and row approach avoids a situation in which an overwhelming number of similar objects are instantiated in the configuration server by representing such objects by row entries in the table. The ConfigurationTableObject 428 extends from the ConfigurationObject class to support this modeling of tabular data. The ConfigurationTableObject 428 additionally supports iteration over the rows of the table. The attributes of the ConfigurationTableObject 428 define the columns of the table.

In the object model 400 of FIG. 4 two mappings are required to operate the configuration server and to handle requests. The first is to map a SNMP set notification to an object attribute pair, allowing incoming configuration change events to be applied to the appropriate object instance and attribute. This mapping is the job of the objects in the AttributeMIBMap object block 410. The second is to map one or more object instance attributes to a CLI command allowing the appropriate object instances and attributes to be utilized when a CLI command object is used, and allowing for CLI command set generation by the configuration server and object model. This second mapping is the job of the objects in the CLICommandItem object block 412.

In mapping a SNMP set notification to an object attribute pair, the MasterAgent 402 notifies the COM (not shown) when a successful configuration event (SNMP set request) is processed. This allows the COM to update the object instances 406, 408 that represent of the state of the chassis. For each SNMP set notification, the COM receives a MIB name, instance, and value. The COM then updates the associated instance and attribute with the value. The update of an object instance due to a configuration event (SNMP set request) triggers rebuilding of the CLI command set for the modified object instance.

As stated above, there are two available manners to map the SNMP set event received from the MasterAgent 402 to an object instance and attribute. First, starting with the chassis, the SNMPSetEvent is passed from parent object to child object within the ConfigurationObject 406, 408 hierarchy, using the instance to route the SNMPSetEnvent to the correct object 406, 408. Second, each object instance attribute registers interest for SNMPSetEvents with a notification service. When the notification service receives an SNMP event corresponding to a MIB name and instance matching a registered object instance, the notification service then notifies the attribute with matching MIB name and instance, gaining the efficiency of not having to pass the SNMPSetEvent from object to object within the ConfigurationObject 406, 408 hierarchy. The notification service/mapping is handled in one embodiment by the objects of the AttributeMIBMap object block 410.

The AttributeMIBMap object class 440 of the AttributeMIBMap object block 410 aggregates attributes that map to a common MIB table. The AttributeMIBMap object class 430 in one embodiment contains a MIB table and provides methods for initialization of the object, computing the instance, and processing (data conversion) incoming and outgoing SNMP MIB name value pairs. The AttributeMIBMap object class 430 also contains methods to perform SNMP sets or gets. The AttributeMIBMap object class 430 contains in one embodiment one or more of the Attribute objects 440 that contain values of the attribute name, MIB name, MIB type, default attribute value, current value, and last known value. This class 430 utilizes a BasTableHelper class 432 to interface with the BasMIBTable 434 that contains instanceList 436 and sequenceList 438 classes. Additionally the class uses the BasMIBCommand class 442 to execute gets and sets. The BasMIB classes are utilized for computing the instance, and processing incoming and outgoing name value pairs.

In mapping one or more object instance attributes to a CLI command, which allows the appropriate object instances and attributes to be utilized when a CLI command is received, objects in the CLICommandItem object block 412 are used. The instances of the ConfigurationObjects 406, 408 each contain objects from the CLICommandItem object block 412 to handle the generation of CLI configuration commands required to represent their own configuration. Each ConfigurationObjects class 406, 408 also knows its contained classes (device 414, chassis 416, module 418, and interface 420) and delegates to the contained classes when a “show running config” command is received, allowing the contained classes to generate their commands. By this walking the configuration object instance tree, commands for the entire managed modular rack chassis are generated. This method also groups the configuration commands by physical and logical components in one embodiment.

In the CLICommandItem object block 412, the CLICommandItem class 444 is a super class for CLICommandSet 448 and CLICommandDefinition 450. The CLICommandItem class 444 contains a single method, buildCommands( ). The buildCommands( ) method generates an ordered set of CLI commands as recursive calls to the other contained configuration object instances and their contained CLICommandItem class instances 444 progresses. Each ConfigurationObject 406, 408 contains a list of CLICommandSet object instances 448. The CLICommandSet object instances 448 provide an ordered list of CLICommandDefinition object instances 450. A CLICommandSet object 448 of a ConfigurationObject instance 406, 408 also contains a list of all CLICommandSets objects 448 of any dependent (child) ConfigurationObject instances 406, 408.

Child ConfigurationObject 406, 408 CLI command sets require the parent ConfigurationObject 406, 408 command to precede the child command sets. This mechanism supports the need to precede commands with other commands due to the logical and physical ordering of the modules in the managed modular rack chassis. The child ConfigurationObject 406, 408 command must be preceded by the parent ConfigurationObject 406, 408 mode command to set the correct mode before setting the child ConfigurationObject 406, 408 command. As an example, if a child CMTS command, such as “downstream frequency”, is issued, it must be preceded by a parent mode command, like “interface cable c/s/p”, to set the correct mode and module before setting the downstream frequency.

The CLICommandDefinition object 450 provides the information required to build a single CLI command. Each CLICommandDefinition object 450 contains the command syntax in the form of a command header, body and trailer inherited from the parent CLICommandItem class 444. The command header is generally a static string that defines the first static tokens of the command. (e.g. “cable downstream”). The body contains a list of CLIParameters in the form of instances of CLIParameterItem objects 452. Each parameter has a value prefix and a value. Pairs of value prefixes and values are used to build the body of the command. The CLIParameterItem objects 452 monitor 458 the values of the corresponding ConfigurationObject 406, 408 MIB Attribute 440 to track any changes in set value. CLIParameterItem objects 452 check to see if they are required by the current configuration for CLI command or CLI command set generation. If a given CLIParameterItem object 452 is not required, the CLIParameterItem objects 452 checks to see if the value matches the default value for the attribute. This allows for filtering of unnecessary default parameters from the CLI command or CLI command set generation of a system or system element. The trailer is used to terminate the command string. In general, the trailer will be null, but it is provided for completeness.

The CLIParameterItem class 452 is a super class for CLIParameterSet 454 and CLIParameterDefinition 456. It supports a single method, buildParameter( ). The buildParameter( ) method generates a single CLI parameter. CLIParameterSet objects 454 contain an ordered list of CLI parameters used to define the body of a CLI command. A parameter set can be one or more ordered CLI commands.

Like CLICommandSet object 448, the CLIParameterSet object 454 provides the ability to nest parameters to support parameter dependencies according to ConfigurationObject 406, 408 relationships. The parameter set of a child ConfigurationObject 406, 408 instance requires a prefix of a parameter of the parent ConfigurationObject 406, 408 instance for proper operation. This allows optional parameters of a child ConfigurationObject 406, 408 instance to include other parameters of a parent ConfigurationObject 406, 408 instance that would be required to provide the correct context. For example, the command, “upstream 1 frequency 40”, includes the child ConfigurationObject 406, 408 instance optional frequency parameter, “frequency 40”, that must be preceded by the upstream channel ID, “upstream 1” parameter of a parent ConfigurationObject 406, 408 instance. In this case the upstream channel ID parameter is a parent, and the frequency parameter is the child. When building the command, the inclusion of the frequency parameter would force the inclusion of the preceding upstream channel ID.

The CLIParameterDefinition object 456 provides the parameter information on a single CLI command. Each CLIParameterDefinition object 456 contains the parameter syntax in the form of a parameter prefix, suffix, and value inherited from the parent CLICommandItem class 444.

Each CLIParameterItem 452 contains a single CLI parameter. A CLI parameter includes the parameter prefix and value. For example, the “downstream frequency 500.0” command contains a single CLI Parameter with prefix “frequency” and value “500.0”. Each CLIParameterItem 452 also provides a boolean value to indicate if it is a required parameter. If it is not a required parameter, it will be included in the command if its associated attribute value is not set to the default value for that attribute, or if an included child parameter requires the parameter. The CLIParameterItem 452 also includes a default flag to indicate if the associated attribute value is set to the default. This flag signals that the parameter should be omitted from the CLI command if the value is the default value and the parameter is not required. Each CLIParameterItem 452 is associated with an attribute (via an Attribute object instance 440) on the ConfigurationObject instance 406, 408. The CLIParameterItem 452 monitors the attribute for value changes. If the value is modified, a flag on the CLIParameterItem 452 is set to indicate the CLIParameterItem 452 no longer reflects the value of the attribute and is in need of updating.

In order to avoid an overwhelming number of instantiated objects, one embodiment models CLIParameterItem 452 objects as rows within a table, as with the ConfigurationTableObject 428 of the ConfigurationObject block 408. The CLIParameterItem 452 is designed to map to a single attribute, so an extension is required to support tabular data. The CLICommandDefinition 450 can be modified to support iteration through table data. For each row, a separate CLI command is generated.

Alternative SNMP agents or configuration server embodiments of the present invention with object oriented programming techniques and configuration component representation will be apparent to those skilled in the art with the benefit of the present disclosure, and are also within the scope of the present invention.

### Conclusion

An object oriented network SNMP agent and configuration server object model and method are described that allows for improved representation of configuration components and management of administered network element, system, or modular rack chassis. The improved SNMP agent and configuration server object model and method also allows for dynamic update of their internal configuration components upon receiving a configuration change event and, additionally, allow for generation of a logically arranged CLI command set without excessive loading of the SNMP agent or configuration server, or degradation of its performance. Additionally, the object oriented SNMP agent or configuration server object model allows for efficient and reduced error implementations of applications of a SNMP agent or configuration server with ease of extension to new additional components and modules.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An object model, comprising:
a plurality of objects, the plurality of objects adapted to contain configuration information and data for a simple network management (SNMP) agent.

2. A computer-usable medium having computer readable instructions stored thereon for execution by a processor to perform a method comprising:
receiving configuration input;
representing the received configuration input in object instances of a plurality of objects, the plurality of objects forming an object model; and
configuring an associated system.

3. The method of claim 2, wherein receiving configuration input further comprises receiving configuration input where the input is selected from the group consisting of configuration files, information databases, and configuration change events.

4. A network element comprising:
a memory;
a network interface;
a processor coupled to the memory and the network interface; and
an object model, the object model comprising: a plurality of objects, the plurality of objects adapted to contain configuration information and data for a configuration server.

5. An object model for a simple network management protocol (SNMP) agent, comprising:
a plurality of objects, the plurality of objects adapted to contain configuration information and data for one or more input configuration datum.

6. In a network element having a memory, a network interface, a computer-usable medium for storing computer readable instructions, and a processor coupled to the memory, the computer-usable medium, and the network interface, an object model, comprising:
a plurality of objects, the plurality of objects adapted to contain configuration information and data for one or more input configuration datum.

7. An object model, comprising:
a plurality of objects, the plurality of objects adapted to contain configuration information and data for a configuration server.

8. A method of forming an object model, comprising:
receiving configuration input; and
representing the received configuration input in object instances of a plurality of objects, the plurality of objects forming an object model.

9. The method of claim 8, wherein receiving configuration input further comprises receiving configuration input where the input is selected from the group consisting of configuration files, information databases, and configuration change events.

10. A computer-usable medium having computer readable instructions stored thereon for execution by a processor to perform a method comprising:
receiving configuration input;
representing the received configuration input in object instances of a plurality of objects, the plurality of objects forming an object model; and
responding to requests for configuration information.

11. The method of claim 10, wherein receiving configuration input further comprises receiving configuration input where the input is selected from the group consisting of configuration files, information databases, and configuration change events.

12. A configuration server comprising:
a memory;
a network interface;
a processor coupled to the memory and the network interface; and
an object model, the object model comprising:
a plurality of objects, the plurality of objects adapted to contain configuration information and data for a configuration server.

13. An object model for a configuration server, comprising:
a plurality of objects, the plurality of objects adapted to contain configuration information and data for one or more input configuration datum.

14. In a configuration server having a memory, a network interface, a computer-usable medium for storing computer readable instructions, and a processor coupled to the memory, the computer-usable medium, and the network interface, an object model, comprising:
a plurality of objects, the plurality of objects adapted to contain configuration information and data for one or more input configuration datum.
